(19) United States
(12) Patent Application Publication
(10) Pub. No.: US 2017/0058509 A1
(43) Pub. Date: Mar. 2, 2017

(54) STRUCTURE CONSTRUCTED USING ADDITIVE MANUFACTURING PROCESS

(71) Applicant: Caterpillar Inc., Peoria, IL (US)

(72) Inventors: James L. Babin, Glasford, IL (US); John Sherman, Peoria, IL (US); Stephen J. Pierz, Peoria, IL (US); Christopher M. Sketch, Peoria, IL (US); Joseph M. Spanier, Metamora, IL (US); Andrew D. Meinert, Metamora, IL (US); Todd D. Crawford, Hanna City, IL (US); Matthew T. West, East Peoria, IL (US)

(73) Assignee: Caterpillar Inc., Peoria, IL (US)

(21) Appl. No.: 14/843,341

(22) Filed: Sep. 2, 2015

(51) Int. Cl. E04B 1/61; E04B 5/44; E04B 1/344; E04B 2/84

(52) U.S. Cl. CPC E04B 1/61; E04B 2/84; E04B 5/44; E04B 1/344; E04B 2001/6195; B33Y 10/00

(57) ABSTRACT

A structure is provided. The structure includes a first component disposed in the first plane. The structure also includes a second component extending from the first component and disposed in a second plane. The second plane is inclined at an angle with respect to the first plane. Each of the first component and the second component are constructed by forming layers parallel to each other using an additive manufacturing process.

### TECHNICAL FIELD

The present disclosure relates to an additive manufacturing process, and particularly to forming a building using the additive manufacturing process.

### BACKGROUND

Recently, structures such as, buildings, houses and the like are being constructed using additive manufacturing methods, such as 3D printing. Typically, in such cases, a design of the structure may be provided to the 3D printing machine which may deposit a material in multiple layers that are parallel to a plane. However, such an implementation may not be used to form the structures comprising different components, such as, floor sections, tilted walls and the like that are inclined at an angle to each other. Conventionally, these structures that include components in different planes are formed using casting or other means and tilted up onto the wall or the base structure.

For reference, GB patent 2,510,598 discloses a 3D printer being sized and adapted for additive manufacture of a building for human habitation. The 3D printer includes a print arm support, a print arm arranged on the print arm support and at least one print head arranged on the print arm, the print head being adapted to selectively deposit layers of building construction material to additively manufacture a building. The print arm is adapted to pivot about a non-horizontal axis centred substantially at the print arm support, such that the print arm sweeps substantially horizontally and circumferentially across the print area.

### SUMMARY OF THE DISCLOSURE

In an aspect of the present disclosure, a structure is provided. The structure includes a first component disposed in the first plane. The structure also includes a second component extending from the first component and disposed in a second plane. The second plane is inclined at an angle with respect to the first plane. Each of the first component and the second component are constructed by forming layers parallel to each other using an additive manufacturing process.

In another aspect of the present disclosure, a method of constructing a structure is provided. The method includes forming a first component of the structure in layers parallel to a base plane using an additive manufacturing process. The method also includes forming a second component of the structure in layers parallel to the base plane using the additive manufacturing process. The second component is disposed on the first component. The method further includes tilting the second component to a plane inclined at an angle with respect to the base plane.

In yet another aspect of the present disclosure, a structure is provided. The structure includes a first component disposed in a first plane and a second component disposed in a second plane inclined at an angle with the first plane. Each of the first component and the second component are formed in layers parallel to each other using an additive manufacturing process. The structure also includes a tilt system disposed between the first component and the second component. The tilt system may be configured to hold the second component in the second plane.

Other features and aspects of this disclosure will be apparent from the following description and the accompanying drawings.

### BRIEF DESCRIPTION OF THE DRAWINGS

FIG. 1 illustrates a perspective view of a structure, in accordance with an embodiment of the present disclosure;

FIG. 2 illustrates a perspective view of the structure being constructed by a printing machine, in accordance with one embodiment of the present disclosure;

FIG. 3 illustrates a perspective view of the structure, in accordance with another embodiment of the present disclosure;

FIG. 4 illustrates a perspective view of a first component of the structure, in accordance with an embodiment of the present disclosure;

FIGS. 5 and 6 illustrates an exemplary tilt system assembled on the first component, in accordance with an embodiment of the present disclosure;

FIG. 7 illustrates a perspective view of a second component of the structure constructed on the first component, in accordance with an embodiment of the present disclosure;

FIG. 8 illustrates a perspective view of the structure; and

FIG. 9 illustrates a flowchart for a method of constructing a structure using an additive manufacturing process.

### DETAILED DESCRIPTION

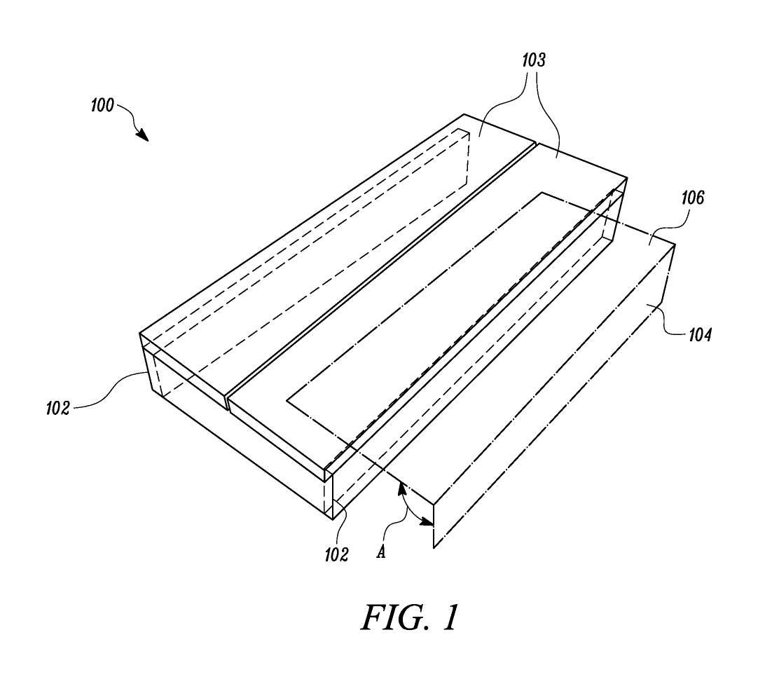

FIG. 1 is a perspective view of an exemplary structure 100 constructed. In the illustrated embodiment, the structure 100 is a building that may be used for human habitat. In other embodiments, the structure 100 may include any structures or parts of the structures such as a house, tilted walls, floor sections and the like. Further, at least a part of the structure 100 may be constructed using an additive manufacturing process that will be described in detail hereinafter.

The structure 100 of the present invention includes a first component 102 disposed in a first plane 104. The structure 100 also includes a second component 103 that extends from the first component 102. Further, the second component 103 is disposed in a second plane 106 that is inclined at an angle ‘A’ with respect to the first plane 104.

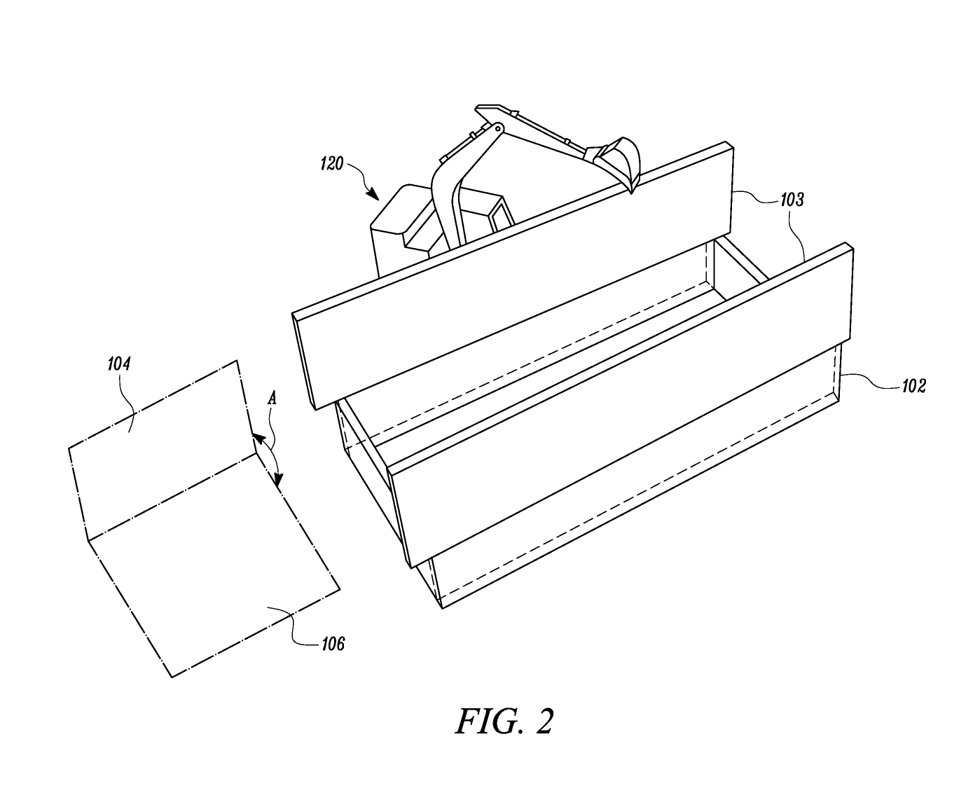

Each of the first component 102 and the second component 103 are constructed by forming layers parallel to each other using an additive manufacturing process. In an example, the additive manufacturing process may include three dimensional (3D) printing. Referring to FIG. 2, the additive manufacturing process may be performed using a printing machine 120, for example, a 3D excavator.

The printing machine 120 may include a depositing head, such as a bucket or a nozzle member that may be configured to deposit a material layer upon layer to form the corresponding part of the structure 100. Further, each of these layers are formed in planes parallel to each other. In an example, the printing machine 120 may also include ground engaging members that are configured to enable movement of the printing machine 120. Further, the printing machine 120 may also include linkage members movably coupled to the depositing head. Such a configuration may enable forming parts of various sizes.

In the embodiment of FIG. 1, the layers are formed perpendicular to the first plane 104. Referring to FIG. 1, the angle ‘A’ between the first plane 104 and the second plane 106 is 90 degrees. As such, the second component 103 that is constructed by forming layers in top of the first component 102 may be tilted by an angle of 90 degrees to consequently form the structure 100.

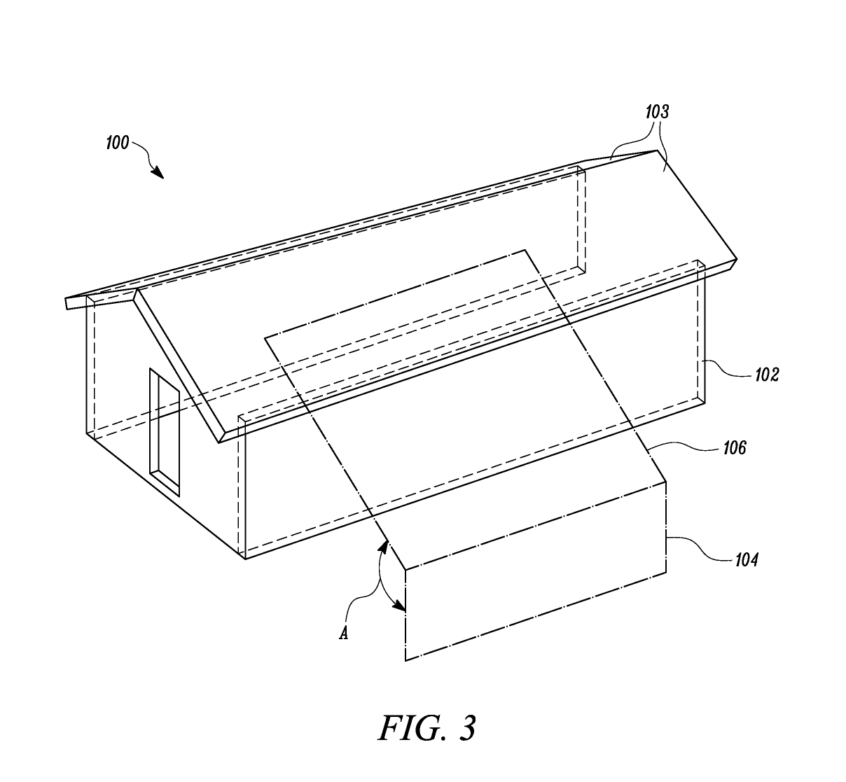

Referring to FIG. 3, the structure 100 according to another embodiment of the present disclosure is illustrated. In the illustrated embodiment of FIG. 3, the angle ‘A’ between the first plane 104 and the second plane 106 lies between 90 to 175 degrees. In various other embodiments, the angle ‘A’ may lie between 5 to 90 degrees.

In the illustrated embodiments of FIGS. 1 to 3, the first component 102 is a wall of the building. Further, the second component 103 forms section of a floor of the building. In an embodiment, the first component 102 and the second component 103 may be formed using construction material and a suitable binding agent. In an example, the material may include concrete. However, it may also be envisioned to use various other materials to form the first component 102 and the second component 103.

Additionally or optionally, the structure 100 may also include a reinforcing layer disposed between the first component 102 and the second component 103. The reinforcing layer may be configured to hold the first and second components 102, 103 in the first and second planes 104, 106 respectively.

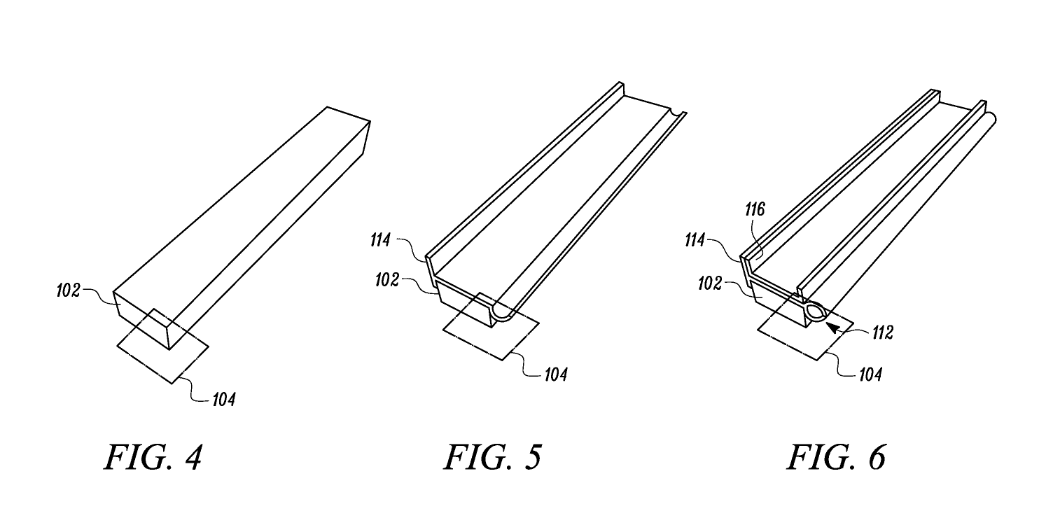

In an embodiment, the structure 100 may further include a tilt system 112 (shown in FIG. 6) configured to hold the second component 103 in the second plane 106. Referring to FIGS. 4 to 8, the tilt system 112, according to one embodiment of the present disclosure is illustrated.

Referring to FIG. 4, the first component 102 disposed in the first plane 104 is illustrated. The first component 102 of the structure 100 may be constructed by forming layers using additive manufacturing process. In the illustrated embodiment, the first component 102 is constructed by forming layers parallel to the first plane 104.

Referring to FIG. 5, the tilt system 112 includes a first hinge member 114 that may be disposed on the first component 102. Further, the first hinge member 114 may be configured to secure the first component 102 therein. Referring to FIG. 6, the tilt system 112 includes a second hinge member 116 disposed on the first hinge member 114. Further, the first and second hinge members 114, 116 may be rotatably coupled to each other.

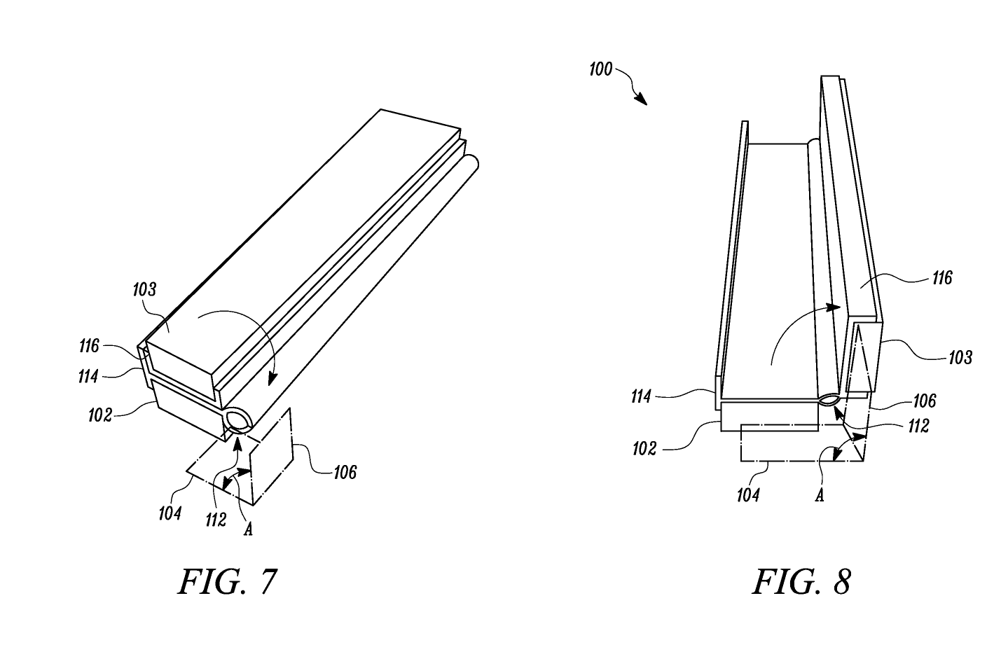

Referring to FIG. 7, the second component 103 constructed by forming layers using the additive manufacturing process is illustrated. In the illustrated embodiment, the second component 103 is constructed by forming layers parallel to the first plane 104. Further, the second component 103 may be formed on the second hinge member 116 that is configured to at least partially enclose and hold the second component 103 therein.

Referring to FIG. 8, the second component 103 being held in the second plane 106 by the tilt system 112 is illustrated. The tilting of the second component 103 may be accomplished using the pivotal coupling between the first hinge member 114 and the second hinge member 116. The second hinge member 116 may be rotated to a suitable angle to obtain the structure 100 of FIG. 8. In an example, other tools or machines may be used to rotate the second hinge member 116 relative to the first hinge member 114.

In an embodiment, the second component 103 may be tilted after the layers forming the second component 103 are cured. A person of ordinary skill in the art will recognize that the tilt system 112 as described herein is merely exemplary in nature and hence non-limiting of this disclosure. Further, the tilt system 112 may embody any type of system based on a type of application.

### INDUSTRIAL APPLICABILITY

The present disclosure relates to the structure 100 that includes the first and second components 102, 103 constructed using the additive manufacturing process and disposed in different planes. These structures 100 may include buildings, houses, or any other complex constructions that include one or more components inclined at different angles with respect to each other. Such constructions including these structures 100 formed using the additive manufacturing process may have improved characteristics compared to conventionally formed structures such as, casted floor sections and the like.

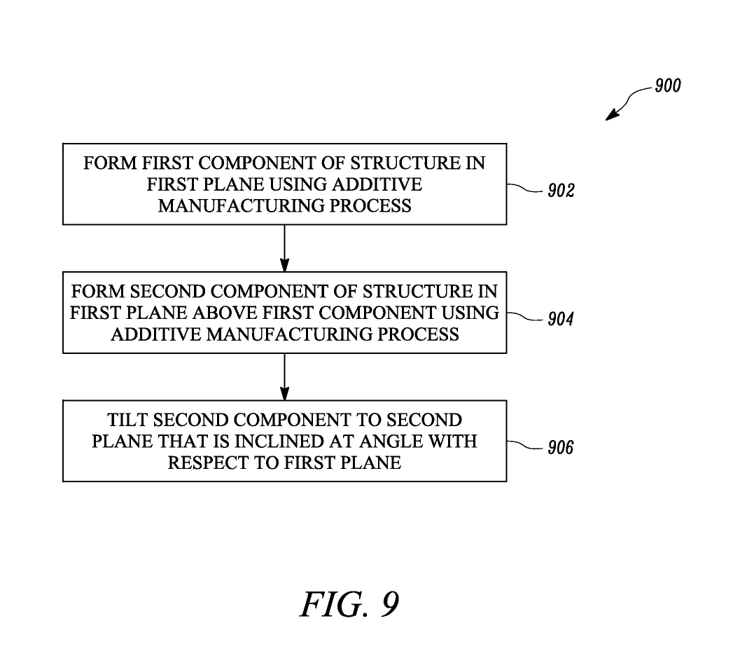

Referring to FIG. 9, a flowchart for a method 900 of constructing the structure 100 is illustrated. In one embodiment, the structure 100 may be a part of a building as illustrated in FIGS. 1 and 3. Moreover, the structure 100 may be any construction that includes the first component 102 and the second component 103 as described with reference to various embodiments of the present disclosure.

At step 902, the method 900 includes forming the first component 102 of the structure 100 in the base plane using the additive manufacturing process. In an embodiment, the base plane may be a plane perpendicular to the first plane 104 of FIGS. 1 to 3. As described above, the first component 102 in such a case is disposed in the first plane 104. In another embodiment, the base plane may be the first plane 104 described with reference to FIGS. 4 to 8.

At step 904, the method 900 includes forming the second component 103 of the structure 100 in layers parallel to the base plane above the first component 102 using the additive manufacturing process. At step 906, the method 900 includes tilting the second component 103 to a plane inclined at the angle ‘A’ with respect to the base plane. The plane to which the second component 103 may be tilted may be the second plane 106 as illustrated with reference to FIGS. 1 to 8. The method 900 may also include allowing the second component 103 to cure before tilting.

In an embodiment, the second component 103 may be tilted to the second plane 106 using the tilt system 112. Although, it is described as using a hinge connection to accomplish the tilting, it may be envisioned to use to any other methods to tilt the second component 103 to the required angle with respect to the first component 102.

With such an implementation, different parts of the construction buildings may be constructed using the additive manufacturing process even though they are disposed in different planes. Further, use of additional support structures to form various components of the structure 100 may also be minimized using the method 900.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A structure comprising:
a wall disposed in a first plane; and
a roof extending from the wall and disposed in a second plane, the second plane inclined at an angle with respect to the first plane, wherein the angle between the first plane and the second plane lies in a range between 90 degrees to 175 degrees, and wherein each of the wall and the roof are constructed by forming layers parallel to each other using an additive manufacturing process.

2. (canceled)

3. The structure of claim 1, wherein the wall and the roof are formed using a construction material and a binding agent.

4. The structure of claim 3, wherein the construction material includes concrete.

5. The structure of claim 1, wherein the additive manufacturing process is a three dimensional (3D) printing process.

6. The structure of claim 1, wherein the additive manufacturing process is performed using an excavating machine.

7. The structure of claim 1 further comprising a reinforcing layer disposed between the wall and the roof.

8. The structure of claim 1, wherein the angle between the first plane and the second plane is 90 degrees.

9. The structure of claim 1, wherein the angle between the first plane and the second plane is between 5 degrees and 90 degrees.

10. A building comprising the structure of claim 1.

11. A method of constructing a structure, the method comprising:
forming a first component of the structure in layers parallel to a base plane using an additive manufacturing process;
forming a second component of the structure in layers parallel to the base plane using the additive manufacturing process, the second component disposed on the first component;
tilting the second component to a plane inclined at an angle with respect to the base plane.

12. The method of claim 11, wherein the structure is formed using a construction material and a binding agent.

13. The method of claim 11, wherein the angle is 90 degrees.

14. The method of claim 11, wherein the angle is greater than 5 degrees.

15. The method of claim 12, wherein the construction material includes concrete.

16. The method of claim 11, wherein the additive manufacturing process is a three dimensional printing process.

17. A structure comprising:
a first component disposed in a first plane;
a second component disposed in a second plane inclined at an angle with the first plane, wherein each of the first component and the second component are formed in layers parallel to each other using an additive manufacturing process; and
a tilt system disposed between the first component and the second component, the tilt system configured to hold the second component in the second plane.

18. The structure of claim 17, wherein the tilt system comprises a pair of hinge members pivotally coupled to each other.

19. The structure of claim 17, wherein the tilt system is further configured to rotate the second component from the first plane to the second plane.

20. The structure of claim 17, wherein the first component constitutes one wall of a building, and wherein the second component constitutes at least a section of a floor of the building.
